(19) United States
(12) Patent Application Publication
(10) Pub. No.: US 2007/0233568 A1
(43) Pub. Date: Oct. 4, 2007

(54) Microtransactions Using Points Over Electronic Networks

(75) Inventors: Robin Pou, Dallas, TX (US); Brad Edmonson, Dallas, TX (US); Dave Jaworski, Franklin, TN (US); Kevin Gorman, Franklin, TN (US)

Correspondence Address: FISH & RICHARDSON P.C., P.O. BOX 1022, MINNEAPOLIS, MN, 55440-1022, US

(73) Assignee: PROVIDENT INTELLECTUAL PROPERTY, LLC, Dallas, TX (US)

(21) Appl. No.: 11/683,820

(22) Filed: Mar. 8, 2007

Related U.S. Application Data
(60) Provisional application No. 60/780,966, filed on Mar. 10, 2006.

(51) Int. Cl. G06Q 30/00; G06Q 40/00

(52) U.S. Cl. 705/14; 705/26; 705/39

(57) ABSTRACT

In some implementations, methods and apparatus, including computer program products, facilitate microtransactions over electronic networks by providing an electronic points currency that can be purchased in bulk and used for purchasing goods and services in microtransactions. In a typical implementation, points may be purchased in bulk quantities that have a value that is large relative to the price of a single product that may be purchased in a microtransaction. A microtransaction vendor may offer products for sale at a discount by setting a first price for purchases made with a credit card and a second lower price for purchases made using points.

### CROSS-REFERENCE TO RELATED APPLICATIONS

This continuation-in-part application incorporates by reference the disclosures of, and claims priority to: 1) U.S. application Ser. No. 10/726,284 to Pou et al., titled “Distribution and Rights Management of Digital Content,” filed on Dec. 2, 2003; 2) U.S. Provisional Patent Application Ser. No. 60/444,581 to Pou et al., entitled “Distribution and Rights Management of Digital Media,” filed on Feb. 3, 2003; and, 3) U.S. Provisional Patent Application Ser. No. 60/780,966, entitled “Microtransactions Using Points Over Electronic Networks,” filed on Mar. 10, 2006.

### TECHNICAL FIELD

Various embodiments may relate generally to electronic currency over an electronic network, and particular embodiments may relate to microtransactions using points as a currency.

### BACKGROUND

Electronic transactions may be made over the Internet at medium and high prices. In exchange for delivering a product or a service, vendors may typically receive payment through a credit card company that handles processing of each individual transaction. When credit cards are used to pay for electronic transactions, the credit card company may charge a fee for each individual transaction. At lower price points, the service fee charged for use of a credit card may generally consume a substantial fraction of the profit margin of a low value individual electronic transaction. This may leave a retail vendor, for example, to face relatively low net profit margins. As such, vendors typically have little incentive to offer products (e.g. goods or services) for sale at very low price points over electronic networks.

Some very low price point transactions over electronic networks may be considered to be microtransactions. Microtransactions typically refer to small transactions that are priced on the order of a few cents to about a dollar, but may sometimes refer to prices up to perhaps five dollars in some cases. Microtransaction could involve low cost products or services, such as a small digital file. One example of a microtransaction may involve the purchase of an article that is downloaded as a digital file that is unbundled from a newspaper.

### SUMMARY

In some implementations, methods and apparatus, including computer program products, facilitate microtransactions over electronic networks by providing an electronic points currency that can be purchased in bulk and used for purchasing goods and services in microtransactions. In a typical implementation, points may be purchased in bulk quantities that have a value that is large relative to the price of a single product that may be purchased in a microtransaction. A microtransaction vendor may offer products for sale at a discount by setting a first price for purchases made with a credit card and a second lower price for purchases made using points.

Some implementations may provide one or more advantages. For example, offering discounts for purchases made with points may promote the widespread adoption and use of points as an electronic currency, which may facilitate growth of a practical market for a wide range of goods and/or services that qualify as microtransactions. In particular, points purchased in bulk may be used to make multiple on-line purchases without each purchase incurring certain transaction costs (e.g., credit card fee) for each transaction. Once points are purchased, transactions may be completed from anywhere in the world using points without conversion between different currencies, which may substantially reduce the costs of international transactions. In a diverse microtransactions market, consumers may conveniently purchase a range of desirable but low cost goods and services from a range of vendors. In addition, vendors may develop new or improved revenue streams by unlocking diverse high volumes markets for low cost goods and services.

The details of one or more example implementations are set forth in the accompanying drawings and the description below. Other features, objects, and advantages will be apparent from the description and drawings, and from the claims.

### DESCRIPTION OF DRAWINGS

FIG. 1 is a schematic diagram illustrating an example process flow in which points are used to complete microtransactions over an electronic network.

FIG. 2 is a schematic diagram of an example network architecture in which a vendor can deliver products and services purchased using points and perform operations as a points bank.

FIG. 3 is an example user interface displayed by a points bank to a user to allow the user to purchase points in bulk.

FIG. 4 is a signal flow diagram illustrating an example sequence of electronic communications between a user and a points bank to purchase points in bulk.

FIG. 5 is a signal flow diagram illustrating an example sequence of electronic communications between a user and a microtransaction vendor to make a purchase using points.

FIG. 6 is a signal flow diagram illustrating an example sequence of electronic communications between a points bank and a microtransaction vendor to redeem points received as a result of one or more microtransactions.

Like reference symbols in the various drawings indicate like elements.

### DETAILED DESCRIPTION OF ILLUSTRATIVE EMBODIMENTS

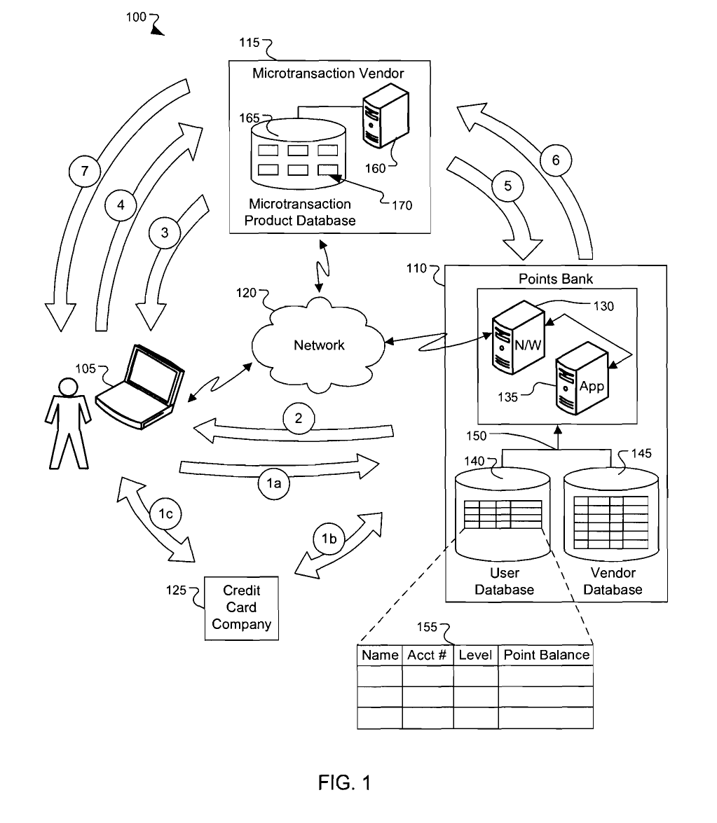

FIG. 1 illustrates an example process flow 100 in which points are processed to complete microtransactions over an electronic network. The flow 100 involves a points user at a terminal 105, a points bank 110, and a microtransaction vendor 115. The terminal 105, bank 110, and vendor 115 are coupled to communicate messages via electronic network 120, which may be a VPN, LAN, WAN, intranet, the Internet, or a combination of such networks. For example, the terminal 105 may include a modem that couples to the network 120 via a DSL line, for example. The points bank 110 may couple to the network 120 through a security firewall with a T1 line. The vendor 115 may have a network interface that couples to a web server that hosts a web page accessible via the Internet. In some implementations, the user terminal 105, bank 110, and vendor 115 may communicate electronic messages to purchase points in bulk, use those points to purchase low cost goods and services in one or more microtransactions, and redeem points for their value.

In this example, the process flow 100 starts with the user initiating a message 1a from the terminal 105 to the bank 110. The message 1a contains a request to purchase points in bulk quantity. In exchange for a bulk quantity of points, the user agrees to pay an agreed price, which may be in a local currency, or in a foreign currency at an agreed exchange rate, for example.

In response, the bank 110 verifies the user's ability to pay by sending an electronic message 1b to a credit card company 125 identified by the user. The credit card company 125 sends a verification message 1b to the bank 110 indicating an acceptance to pay the proposed charges to the user's account. Typically, the credit card company will charge the bank 110 a transaction fee for the cost of processing the transaction to purchase the points. The credit card company 125 sends a message 1c to the user. The message 1c is typically in the form of a monthly statement or invoice showing a debit of the amount of the purchase price of the points, and may include other fees and/or finance charges.

In other examples, the user may offer to pay the bank 110 for the points using assets (e.g., checking, savings) already on deposit with the bank 110. In some other examples, the bank 110 may extend credit to the user in exchange for some consideration, such as interest on the outstanding balance that the user owes to the bank 110, for example. The bank 110 may check the user's credit report in combination with one or more of the above.

After verifying ability to pay, the bank 110 sends a message 2 to the terminal 105 to indicate acceptance of the request to purchase a bulk quantity of points. If the bank 110 does not already have a user account on record, the bank 110 may establish one on behalf of the user. In some cases, the bank 110 may associate the points with an identification value, such as an email address, password, serial number, account number, user name, or combination of such identifying information.

In addition to confirming the purchase, the message 2 may include information such as points balance, amount charged, exchange rate (e.g., for purchases made with foreign currency), and/or supplementary information. In some implementations, supplementary information may include authorization codes to present to vendors, public and/or private key or digital certificate information, which may include redemption information, that may be presented to a vendor when making purchases using points. In some implementations, such supplementary information may further include marketing and/or promotional information relating to, for example, discounts being offered by microtransaction vendors for purchases made using points. Such supplementary information may be incorporated in XML, HTML, text, graphics, video (e.g., .mpeg, .gif file types), audio (e.g., .wav files), email, JAVA, Applets, servlets, hyperlinks, and/or other objects, alone or in combination, that may be embedded in and/or associated with the electronic messages. Such supplementary information may contain or link to information over a network, such as the Internet, to facilitate the purchase, use, and/or redemption of points that may be used in microtransactions or other on-line transactions.

After purchasing a bulk quantity of points, the user may proceed to using the terminal 105 to use points to purchase goods and/or services (hereinafter referred to generally as “products”) over the network 120. In this example, the user terminal 105 receives a message 3 from the vendor 115. In some embodiments, the message 3 may be an email, an instant message, or a web page downloaded into a web browser program running on the terminal 105. Those of skill in the art will recognize other forms for the messages between the terminal 105 and the vendor 115. The message 3 contains information about products available for purchase from the vendor 115. In some implementations, the products may include one or more low cost products that may be classified as microtransaction products. The user may receive multiple messages 3 while searching for information to identify a product that the user decides to purchase.

In some implementations, the vendor 115 may offer the products for sale in a currency that is a foreign currency with respect to the user's local currency, and the vendor 115 may further offer products for sale in exchange for a certain number of points. In some implementations, the vendor 115 offers at least one product for sale at a certain price for purchases made using a credit card, while offering the at least one product for sale at a discounted price for purchases made using points. For purchases made using points, the vendor 115 does not incur costs associated with credit card fees for each individual transaction. As such, some or all of the cost savings may be provided in the form of a price discount for purchases made using points.

The user may transmit a message 4 to the vendor with one or more selected products for purchase. In an example, the message 4 identifies a selected product and an associated points price determined from information contained in the message 3. In other implementations, the message 4 may contain an offer price supplied by the user. In some cases, the offer price supplied by the user may be a counter-offer that differs from the quantity and/or price terms contained in the message 3. In some further implementations in which the selected product is being offered in an auction, the message 4 may contain a bid of a certain number of points for the product. In some cases, the offer may be made by making a prescribed user input on specified input controls on a web page. In some other cases, the offer may be in the form of text in an email message. Other suitable methods for communicating an offer in the message 4 will be recognized by those of skill in the art.

In some other examples, the vendor 115 may automatically accept the user's offer in the message 4 if the offer meets qualifying criteria, such as being less than a threshold (nominal) value, or the user being pre-qualified by the vendor 115 for certain transaction amounts.

After receiving the message 4 from the user, the vendor 115 processes the message 4 to determine if it is understandable. If the offer is to be rejected based on terms such offer price, then the vendor 115 may automatically respond with a rejection message.

However, if the offered terms in the message 4 are acceptable, then the vendor 115 may verify the validity of the offer to pay with points by sending a message 5 to the bank 110. The message 5 may include information sufficient to identify the particular points offered by the user, or to verify the existence of sufficient points in the user's account. In some implementations, the bank 110 may place a hold on points in the user's account sufficient to offset the points being offered to the vendor 115 by the user. In some implementations, the bank 110 may certify that the user has sufficient points available on account based upon an overdraw feature by which the bank 110 withdraws other funds on deposit or available credit with the bank 110 to cover the number of points offered by the user to purchase the product from the vendor.

In response to the offer to pay points to make a purchase, the bank 110 sends a message 6 to the vendor 115 to indicate that the points being offered to fund the transaction are in fact available to the user. In some implementations, the user may offer points that are drawn from more than one points bank and/or more than one account. In such cases, some points may be drawn from each of at least two banks. The user may specify what precedence or limits to place on points in each points bank or account.

When the vendor 115 has determined to accept the offer from the user, the vendor sends a message 7 to the user terminal 105. The message 7 contains an indication of acceptance of the offer, and may further include information about the delivery, shipment, or other aspects auxiliary to completing the transaction. In some examples, the message 7 may include some or all of the product to be delivered (e.g., downloaded music file). The transaction may conclude with the user receiving the purchased product from the vendor 115. When the purchased product includes digital content, various techniques may be used to manage distribution and/or rights associated with the digital content. Examples of such techniques, for example, are described in U.S. application Ser. No. 10/726,284 to Pou et al., titled “Distribution and Rights Management of Digital Content,” filed on Dec. 2, 2003, and U.S. Provisional Patent Application Ser. No. 60/444,581 to Pou et al., entitled “Distribution and Rights Management of Digital Media,” filed on Feb. 3, 2003, each of which is incorporated herein by reference in its entirety.

The points bank 110 of this example includes a network server 130 and an application server 135. The network server 130 handles message traffic to and from the network 120, and may provide various message handling, security, firewall, and routing functions, for example. Inbound and outbound messages are transferred between the network server 130 and the application server 135, which runs application software to perform operations in support of the purchase and redemption of points as described above. Application programs for purchasing and redeeming points running on the network server 135 store and retrieve information in a user points database 140 and a vendor points database 145, respectively, via a local area network 150. The user points database 140 includes an information table 155 that contains information about the points balance, points level, and account number associated with each of a plurality of users. In some examples, a user may have more than one account. The vendor points database may contain a similar information table about points balance of vendors. In some examples, the user and vendor databases may be contained in a common database.

In some implementations, a points bank 110 may sell points to users or to vendors (e.g., for promotional purposes) at a first (sell) exchange rate, and redeem points to users or vendors at a second (redemption) exchange rate. The difference between the sell and redemption exchange rates may provide revenue for the bank 110.

In some implementations, the bank 110 may adjust the redemption exchange rate such that vendors, for example, have an incentive to delay redeeming points for cash. Although points may be redeemed at any time, the bank may at times offer preferential exchange rates for vendors who redeem less frequently.

In some implementations, the level assigned to each account in the information table 155 may be based on each account's points usage level. Users who have purchased and/or used at least a first level of points in a period of time, for example, may be upgraded from a basic level to an intermediate level. Users who have purchased and/or used at least a second (higher) level of points in a period of time, for example, may be upgraded from a the intermediate level to a premium level. Based upon the accounts level, points may be, for example, purchased and/or redeemed at preferential exchange rates. Level may also be used to determine service level, such as the level of customer support (e.g., email only, web chat, live telephone support) or other privileges provided by the points bank 110.

The microtransaction vendor 115 in this example includes a computer system 160 to interface to the network 120 and to run application software in support of product sales operations. Product sales operations typically include offering products for sale to users (e.g., on a web page), handling point verification and point redemption with the bank 110, and delivering purchased products to users. Product information is stored in a microtransaction product database 165 that contains information objects 170 about one or more products being offered for sale by the vendor 115. Some of the information objects 170 are each be associated with a points price, or dynamically associated with an asking price, a reservation price, and/or one or more bids submitted by users in the message 4.

In various embodiments, the messages communicated over the network 120 among the terminal 105, the bank 110, and the vendor 115 may be encrypted for privacy. Various encryption methods may be used that are familiar to persons of skill in the art. Examples of encryption protocols or techniques that may be used for e-mail and/or Internet messages include secure http (https), PGP, secure socket layer (SSL), secure transport layer (TLS), S/MIME, secure shell (SSH). In some embodiments, the messages communicated over the network 120 may involve bidirectional communication of data (e.g., in packet form) to authenticate the user (e.g., using login/password, challenge-response, biometric data), to correct data errors (e.g., re-tries), and/or to confirm information, for example.

In a diverse points market, points may be purchased from authorized points banks in various countries, or from a central points bank that serves as a clearinghouse for points.

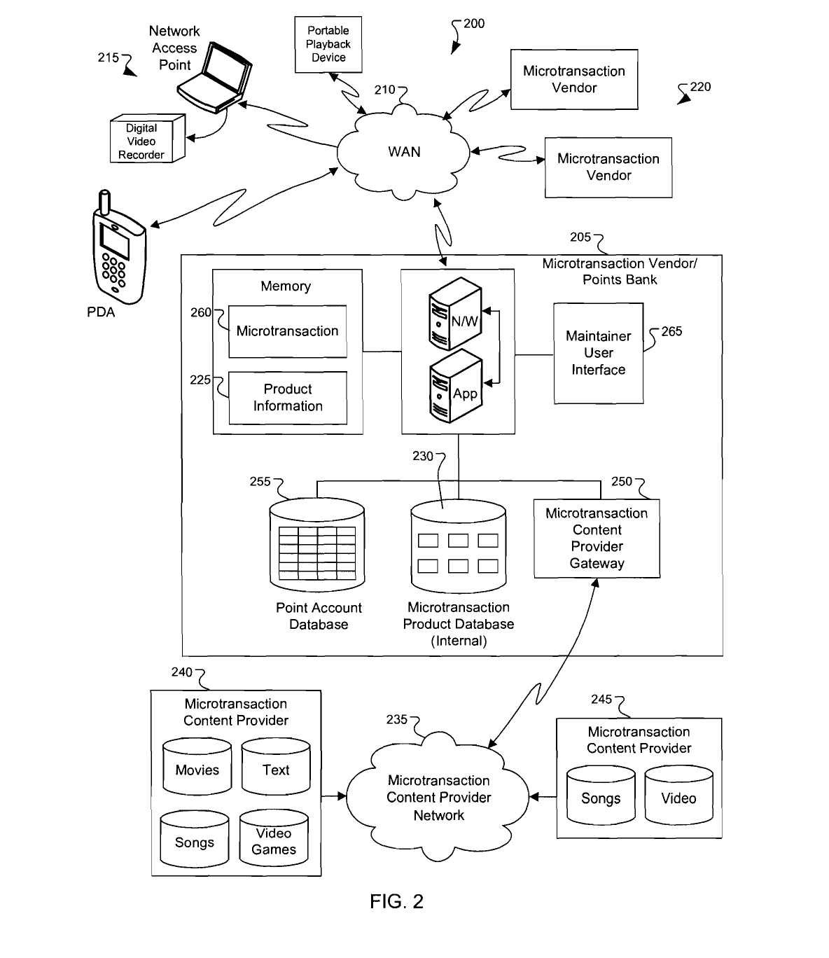

FIG. 2 is a schematic diagram of an example network architecture 200 in which a vendor can both deliver products purchased using points and perform operations as a points bank. The network 200 features a microtransaction vendor/points bank 205 coupled via a wide area network (WAN) 210 to a number of devices 215 configured to receive products purchased with points. The products may be purchased from the vendor/bank 205, or from the any of a number of other microtransaction vendors 220 also coupled to the WAN 210.

Each of the devices 215 may send messages to purchase a bulk quantity of points from the vendor/bank 205, spend the points to make microtransaction purchases of products at the vendors 205, 220, and/or receive delivery of the purchased products, such as songs, videos, or data. The devices 215 include a portable playback device to playback downloaded songs, a digital video recorder coupled to a laptop computer to playback videos, and a portable digital assistant to display textual information. These capabilities are merely exemplary, and not intended to be limiting.

Some digital content that may be purchased using points can be retrieved from, for example, a product information memory of the vendor/bank 205, a microtransaction product database 230 internal to the vendor bank 205, and/or various content providers coupled to the vendor/bank through a microtransaction content provider network 235. The network 235 is coupled to a microtransaction provider 240 that can serve movie, text, songs, and/or video game content to the vendor/bank 205. The network 235 is also coupled to a microtransaction provider 245 that can serve songs and/or video content to the vendor/bank 205. Both content providers 240, 245 may provide content that the vendor/bank 205 may offer for purchase in exchange for points at the microtransaction level.

The vendor/bank 205 includes a microtransaction content provider gateway 250 that interfaces with content provider partners. Information about available content may be uploaded through the gateway 250 and stored in the product information memory 225. When selected for purchase by a point user, the vendor/bank 205 can cooperate with the content providers 240, 245 to deliver the content to the purchaser. In other examples, numerous other content providers may arrange to supply content for purchase using points through the vendor/bank 205 and/or the other vendors 220.

As described above with reference to FIG. 1, the vendor/bank 205 processes messages that contain offers to purchase products using points. The vendor/bank 205 provides both vendor functions and bank functions in one integrated environment, thereby simplifying processes described above with reference to the messages 5, 6. For example, when the vendor/bank 205 receives an offer to purchase a selected product using points at the microtransaction level, the offer may be verified internally by accessing a points account database 255 in internal memory (or data storage device). The vendor/bank 205 also internally accounts for the receipt of points from the user's account, thereby simplifying the operation of redeeming points.

The vendor/bank 205 includes a maintainer user interface 265 to provide for maintenance of the microtransactions vendor operations and the points bank operations. For example, the user interface 265 provides access to update and manage data and database structures relating the points account information and product information (e.g., current pricing, currently available content from partners).

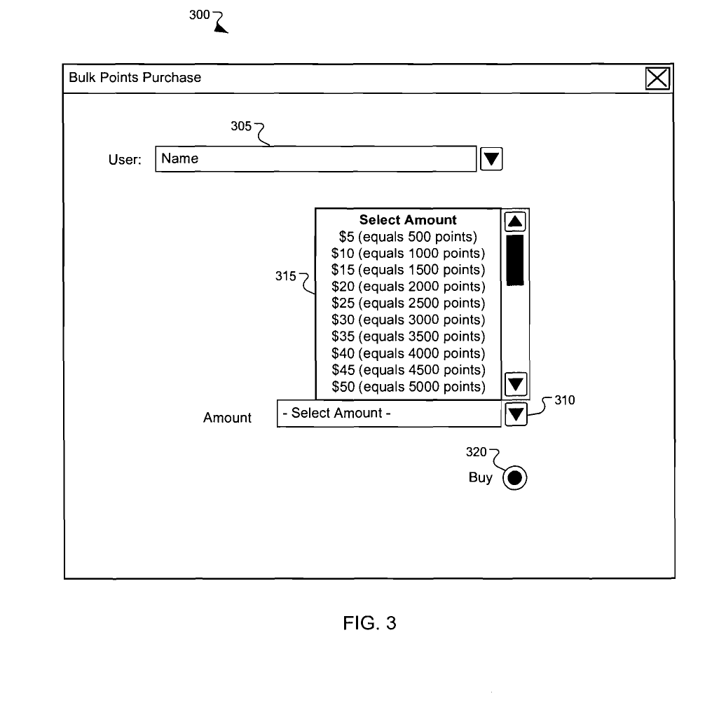

FIG. 3 is an example user interface 300 sent for display, for example, by the points bank 110 or the vendor/bank 205, to a display device on the terminal 105 or one of the devices 215. The user interface provides for user input to specify a purchase of points in one of a number of bulk quantities. The user interface 300 may be, for example, a frame in a web page generated using HTML, XML, JAVA, or other suitable language.

The user interface includes an input field 305 for defining the user's identity so that points the bank can associate purchased points with the user. In some implementations, additional inputs may be required to authenticate the user's identity, such as a combination of a login and password. In the depicted implementation, the user interface may have already authenticated the user, but the input field 305 allows the user to specify other recipients' accounts for the purchased points. As such, the user interface 300 may be used to purchase a bulk quantity of points for friends or family members.

The user interface 300 also includes an amount selection input control button 310. When the button 310 is selected by the user, a list box 315 displays available bulk quantities of points for purchase. In this example, points may be purchased at a rate of one U.S. dollar for each one hundred points, and a minimum of five dollars may be purchased. The user can select (e.g., highlight) a desired quantity of points to purchase, and then execute the purchase by selecting a buy input control button 320.

Typically, several microtransactions may be completed with a bulk quantity of points. For example, after purchasing a bulk quantity of points from a points bank, a user will typically have enough points to purchase several items at the microtransaction level, such as, a recipe, a newspaper article, a popular song, and a humorous video clip.

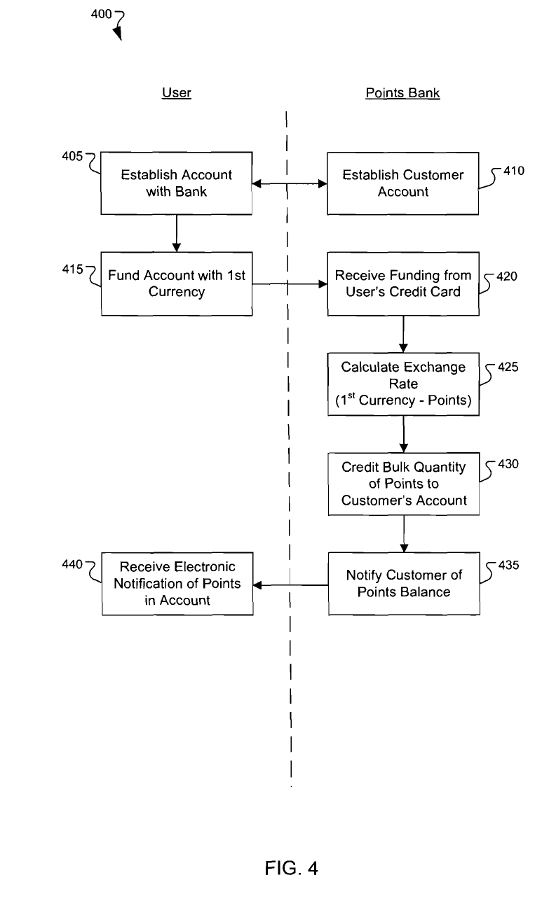

FIG. 4 is a signal flow diagram illustrating an example method 400 for electronic communications between a user and a points bank to purchase points in bulk. When instructions stored in a memory coupled to a processor in the application server 135, for example, are executed by the processor, the processor may cause operations of the method 400 to be performed. Such stored instructions may be tangibly embodied in an information carrier that forms a computer program product.

The method 400 begins at step 405 with a prospective points user establishing a points account with a bank, such as the points bank 110. The points bank 110 responds by establishing a points account for the user at step 410. Next, the user funds the account with a first currency denomination (e.g., U.S. Dollars, Japanese Yen, Swiss Francs) in step 415, which the points bank receives, in step 420 of this example, from the user's credit card company 125. The points bank 110 then calculates, at step 425, an exchange rate to convert the specified amount of the first currency into a number of points based on an exchange rate. Typically, the value of the purchased points will be sufficiently large relative to the value of a typical microtransaction that the user will be considered to make a bulk purchase of points.

After determining the number of points, the bank 110 credits, in step 430, the bulk quantity of points to the account established in step 410. In step 435, the bank 110 notifies the customer of the current points balance in the user's account. As was described with reference to the message 2 in FIG. 1, the user receives electronic notification of the balance of points in the user's account in step 440.

After having established, funded, and filled an account with a bulk quantity of points according to the method 400, the user may proceed to use the points to make purchases at the microtransaction level.

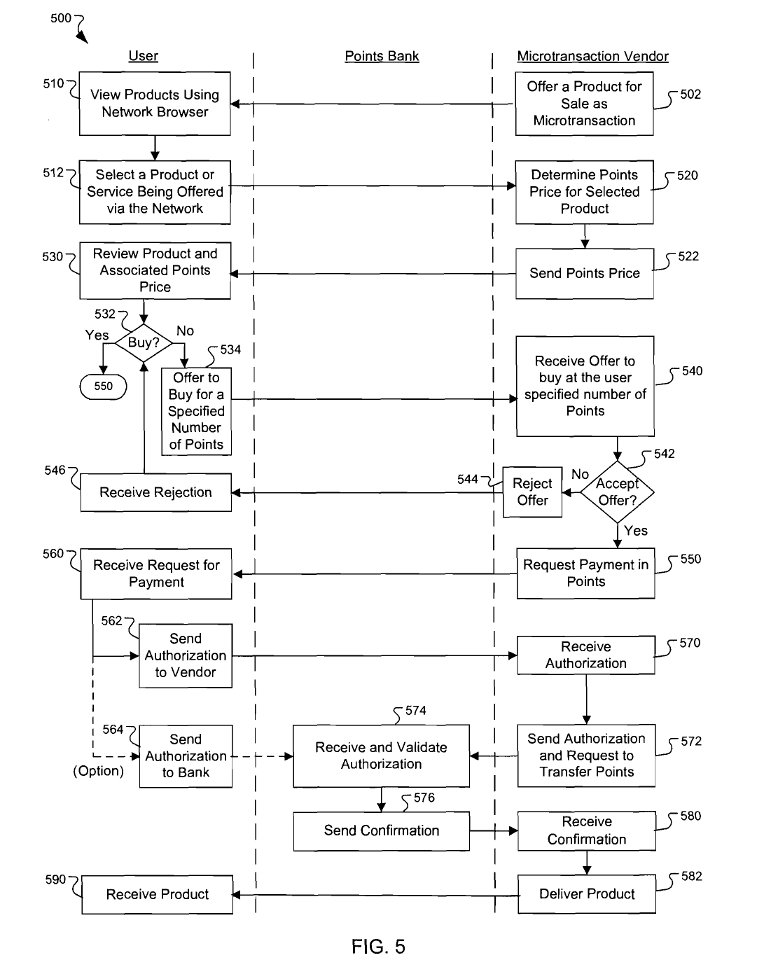

FIG. 5 is a signal flow diagram illustrating an example method 500 of electronic communications between a user and a microtransaction vendor to make a purchase using points. Operations of the method 500 may be performed, at least in part, by a processor on the computer system 160 executing instructions stored in a memory coupled to the processor. The stored instructions may be tangibly embodied in an information carrier and form a computer program product.

In this implementation, the method 500 begins at step 502 with the microtransaction vendor, such as the vendor 115 of FIG. 1, offering a product (e.g., good and/or service) for sale at a microtransaction level. In step 510, a user may view the offered products using a network browser running, for example, on the user terminal 105. The user selects a product being offered via the network 120 at step 512. The vendor 115 receives the selection at step 520 and determines a points price for the selected product, and the vendor sends the points price to the user at step 522.

At step 530, the user reviews the product and associated points price. At step 532, the user determines whether to buy the product at the points price. If the user decides to buy at that price, then the no negotiation takes place, and the method proceeds to step 550 (described below). If the user decides not to buy at the price, then the user tries to negotiate an offer to buy for a specified number of points at step 534. At step 540, the vendor 115 receives the offer to buy at the user for the specified number of points. At step 542 the vendor decides whether to accept the offer. If the vendor does not accept the offer, then at step 544 the vendor sends an offer rejection message to the user. At step 546, the user receives the rejection, and step 532 is repeated.

If the vendor does accept the offer, then at step 550 the vendor sends a request for payment in points. At step 560, the user receives the request for payment. At step 562, the user sends an authorization to the vendor, which authorization may include account information that may be verified by the bank 110. The vendor receives authorization at step 570, and sends the authorization and request to transfer points at step 572 to the bank 110.

Optionally, after step 560, the user may send an authorization directly to the bank to release the agreed number of points to the vendor 115.

In either case, the bank 110 receives and validates the authorization at step 574, and then sends a confirmation message at step 576 to the vendor 115. After receiving the confirmation message at step 580, the vendor 115 undertakes to the deliver the product at step 582. At step 590, the user receives the product, and the method 500 is completed.

After having completed a microtransaction level purchase using points according to the method 500, the vendor 115 may proceed to redeem the points received in the course of one or more purchases to a local currency (e.g., U.S. Dollars, British Pound).

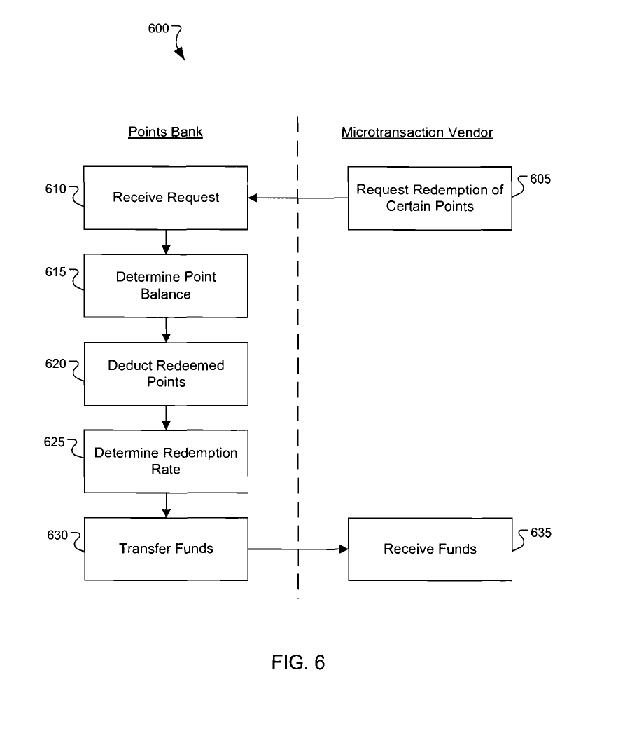

FIG. 6 is a signal flow diagram illustrating an example method 600 of electronic communications between a points bank and a microtransaction vendor to redeem points received as a result of one or more microtransactions. Some operations of the method 600 may be performed, at least in part, by a processor on the application server 135 executing instructions stored in a memory coupled to the processor. Some other operations of the method 600 may be performed, at least in part, by a processor on the computer system 160 executing instructions stored in a memory coupled to the processor. The stored instructions may be tangibly embodied in an information carrier and form a computer program product.

In this implementation, the method 600 begins at step 605 with the microtransaction vendor, such as the vendor 115 of FIG. 1, sending a message to request redemption of a certain number of points in the vendor's account. At step 610, the points bank 110 receives the request, and determines the vendor's point balance at step 615 by retrieving information from the vendor database 145. At step 620, the points to be redeemed are deducted from the vendor's point balance. A current redemption rate is determined as step 625.

As described elsewhere herein, the redemption rate may be a function of the time the vendor waited to redeem the points. For example, the points may be redeemed at a preferred rate the longer the average length of time the bank has held on to the points prior to redemption. In accounting for the average length of time, in some implementations, a first-in-first-out (FIFO) accounting method may be adopted. In some other implementations, a last-in-first-out (LIFO) accounting method may be adopted. In still other implementations, points may be identified with lots for purposes of determining holding period by the points bank 110.

After determining a redemption rate, the points bank 110 transfers at step 630 an amount of funds corresponding to the number of points and the applicable redemption rate to the vendor 115.

At step 635, the vendor 115 receives the transferred funds, and the method 600 is completed.

Although an example online system for storing points information to be used in making microtransaction purchases over electronic networks, such as the Internet, has been described with reference to FIGS. 1-2, points may also be stored in other implementations. For example, points information may be stored in a portable memory, such as on a flash memory card in a cellular phone or PDA, on a thumb drive, or on a magnetic strip of a credit-card sized card.

A product purchased using points may include a wide variety of goods, services, or a combination thereof. By way of example and not limitation, the product may include digital information, including files, compiled information, streaming audio and/or video content, images, applications, software modules, objects, codes, hyperlinks, and the like. Typical products may relate to individual songs, cheat codes for games, access to on-line content (e.g., interactive games, jib-jabs), white papers, PDF documents (e.g., financial analysis or reports for stocks and/or bonds), individual newspaper or magazine articles, electronic greeting cards, application files, plug-in modules for software, feature upgrades, jokes, video clips, animations, screen savers, emoticons, background schemes, document templates, recipes, and various other content, at least some of which may be purchased at the microtransaction level. Services, for example, that may be purchased with points at the microtransaction level may include subscriptions to cellular telephone and/or data services charged by the number of bits sent or received, access to browse premium websites charged by time (e.g., second, 1 minute, 5 minutes, 15 minutes, hour, day).

Points may be used to purchase various other goods and services. For example, points may purchase enhanced customer support, extend warranties, provide enhanced access to exclusive offers, higher download rates (e.g., for streaming radio or video), higher priority download access (e.g., less waiting time at mirror download sites), and/or improved levels of product shipping (e.g., overnight, priority). Various access levels may be purchased with incremental points, such as access to extended playing time, multiple or unlimited plays (instead of one-time use), extra movie scenes (e.g., deleted cuts), early access to products, and similar benefits.

Although some implementations may involve paying points for time spent or pages accessed at a premium website, other implementations may involve receiving points for accessing and/or interacting with certain web sites. For example, a user may receive points for filling out an on-line survey, submitting product reviews, visiting selected web pages or advertisements. Product promotions may include, for example, providing points to the first predetermined number of users to visit a site or take a prescribed action over the Internet. Points may be randomly distributed to current viewers of a web site to incentivize visitors to delay browsing away from a web page.

Some web hosting services, for example, may use points to incentivize web sites based on the traffic they can generate. Web sites that attract a high number of visitors may receive points based on recorded traffic.

In another example, some groups may give points for referrals. For example, if a visitor to a vendor web site forwards a link to a product to another person who then buys the linked product, then the visitor may receive points for providing the referral.

Point usage may be used as a basis to provide different levels of service, for example. For example, a vendor may provide special premium content on a limited basis to customers who spend points at a first threshold rate over time with the vendor. The vendor may provide exclusive and/or unlimited access to premium content to users who spend points above a second rate that is greater than the first rate. For example, the higher rate point users may receive exclusive access to content before other users. In other examples, high rate users may receive live, free customer support, additional services, and the like.

Similarly, points discounts may be offered based on timely action of potential customers. For example, vendors or advertisers may offer discounts that decrease over the course of a promotional period, such as an hour, day, week, or month. In some examples, discounts may be adjusted in step-wise fashion, linearly, or exponentially with time.

In some implementations, points-based transactions may be traceable by identification information that is maintained in association with individual points. In some cases, metadata may be associated with points. For example, age of a purchaser may be associated with some points. Such metadata may be used to filter access to some products, such as access based on ratings of movies and/or movie trailers (e.g., G, PG, PG-13, R) or video games (e.g., E, T, M). In other implementations, individual points are not associated with identifying information, and are not inherently traceable.

In an illustrative example, a website may be accessible by various computing devices, including portable wireless players that are able to connect to the Internet and listen to songs, for example. In some cases, the website may be accessible by wireless players through a wireless connection to the Internet. A device user may access the site to search, purchase, and/or download songs from the website directly from one of the wireless players. In various implementations, songs may be purchased using points acquired by the user. Advantageously, one or more such purchases may be made without billing to a non-points instrument such as a credit card. In such cases, no credit card information would need to be entered to make purchases using wireless players. Accordingly, points-based purchases may advantageously facilitate purchases by providing a simple, user friendly mechanism that substantially avoids user-intensive labor and/or security risks associated with entering credit card information into a portable wireless communication device. Using the wireless player, a user may purchase points products from the website using a portable, hand held, desktop, or other Internet-connected computer device. After purchasing points, the user may use the wireless player to simply and rapidly start purchasing songs (or other digital content) with just a few confirmation clicks. In addition to downloading to wireless players, users may also use a desktop computer to purchase content using points, for example. Downloaded content may be transferred among different computers, such as between a PC and the wireless player. Some implementations may provide for securely transferring song licenses to wireless players. For example, information may be transmitted on secure channels, and multi-form authentication validations may be performed on the servers to accurately identify service consumers.

Some embodiments of the invention may be implemented in a computer system. For example, various embodiments may include digital and/or analog circuitry, computer hardware, firmware, software, or combinations thereof. Apparatus can be implemented in a computer program product tangibly embodied in an information carrier, e.g., in a machine-readable storage device or in a propagated signal, for execution by a programmable processor; and methods can be performed by a programmable processor executing a program of instructions to perform functions of the invention by operating on input data and generating an output. The invention can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits).

In some embodiments, one or more user-interface features may be custom configured to perform specific functions. The invention may be implemented in a computer system that includes a graphical user interface and/or an Internet browser. To provide for interaction with a user, some embodiments may be implemented on a computer having a display device, such as a CRT (cathode ray tube) or LCD (liquid crystal display) monitor for displaying information to the user, a keyboard, and a pointing device, such as a mouse or a trackball by which the user can provide input to the computer.

In various embodiments, the user terminal, points bank, and vendor may communicate using suitable communication methods, equipment, and techniques. For example, the vendor may send or receive messages over a bus and/or using point-to-point communication in which a message is transported directly from the source to the receiver over a dedicated physical link (e.g., fiber optic link, point-to-point wiring, and daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, and the computers and networks forming the Internet. Other embodiments may transport messages by broadcasting to all or substantially all devices that are coupled together by a communication network, for example, by using omni-directional radio frequency (RF) signals. Still other embodiments may transport messages characterized by high directivity, such as RF signals transmitted using directional (i.e., narrow beam) antennas or infrared signals that may optionally be used with focusing optics. Still other embodiments are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, or multiplexing techniques based on frequency, time, or code division. Some implementations may optionally incorporate features such as error checking and correction (ECC) for data integrity, or security measures, such as encryption (e.g., WEP) and password protection.

A number of implementations of the invention have been described. Nevertheless, it will be understood that various modifications may be made without departing from the spirit and scope of the invention. For example, advantageous results may be achieved if the steps of the disclosed techniques were performed in a different sequence, if components in the disclosed systems were combined in a different manner, or if the components were replaced or supplemented by other components. The functions and processes (including algorithms) may be performed in hardware, software, or a combination thereof, and some implementations may be performed on modules or hardware not identical to those described. Accordingly, other implementations are within the scope of the following claims.

What is claimed is:

1. A method to facilitate electronic microtransactions, the method comprising:
offering points for purchase in bulk quantities, wherein points comprise a currency for on-line microtransactions; and
allocating a bulk quantity of points to a user in exchange for consideration,
wherein the consideration substantially exceeds the purchase price of a single product being offered for sale in a microtransaction.

2. The method of claim 1, wherein the product being offered for sale comprises a service.

3. The method of claim 1, wherein the product being offered for sale comprises an item.

4. The method of claim 1, wherein the product being offered for sale comprises electronic information.

5. The method of claim 4, wherein the electronic information comprises audio information.

6. The method of claim 4, wherein the electronic information comprises video information.

7. The method of claim 4, wherein the purchased information comprises text information.

8. The method of claim 4, wherein the purchased information comprises an electronic file downloadable via an electronic communication channel.

9. The method of claim 1, wherein the value of each individual point is substantially less than the purchase price of a single on-line microtransaction.

10. The method of claim 1, wherein the on-line microtransaction comprises exchanging points for a product being offered over an electronic network.

11. The method of claim 10, wherein the electronic network comprises a wireless portion configured to communicate with at least one wireless device.

12. The method of claim 10, wherein the product being offered over the electronic network is offered at a discounted price for purchases made using points.

13. The method of claim 1, wherein each of the points has equal commercial value.

14. The method of claim 1, further comprising completing a plurality of microtransactions.

15. The method of claim 14, wherein completing each of the plurality of microtransactions comprises exchanging at least one product for some of the points in the bulk quantity of points.

16. The method of claim 15, further comprising offering the at least one product at a discounted price for transactions that are made using points.

17. The method of claim 16, further comprising offering the at least one product at an undiscounted price for transactions that are made without using points.

18. The method of claim 14, wherein completing microtransactions comprises purchasing information.

19. A method to facilitate electronic microtransactions, the method comprising:
offering a product or service for purchase on-line at a first price for purchases made using a credit card; and
offering the product or service for purchase on-line at a discounted price for purchases made using points, the discounted price being less than the first price,
wherein points comprise a currency for on-line microtransactions over an electronic communication channel.

20. The method of claim 19, wherein the value of each individual point is substantially less than the discounted purchase price.

21. The method of claim 19, wherein the electronic communication channel comprises a wireless communication channel.

22. The method of claim 19, wherein the electronic communication channel comprises the Internet.

23. The method of claim 19, wherein a value of each individual point is between about 25% and about 50% of the discounted price.

24. The method of claim 19, wherein a value of each individual point is between about 1% and about 25% of the discounted price.

25. The method of claim 19, wherein a value of each individual point is less than about 1% of the discounted price.

26. The method of claim 19, wherein each of the points has substantially equal commercial value.

27. The method of claim 19, wherein the on-line microtransactions comprise an exchange of points for the offered product or service.

28. The method of claim 19, wherein the on-line microtransactions comprise a purchase of information.

29. The method of claim 28, wherein the purchased information comprises at least one type of information selected from the group consisting of: audio information; electronic text information; video information; and, an electronic file for download via an electronic communication channel.

30. The method of claim 19, further comprising redeeming a plurality of points in exchange for consideration, the value of which is based on the value of the redeemed points.

31. A method to facilitate electronic transactions, the method comprising:
offering points for purchase in bulk quantities, wherein points comprise currency for making microtransactions;
providing access to a bulk quantity of points in response to receiving consideration in exchange for the provided access; and
offering a product or a service for purchase in exchange for a first number of the points, wherein the received consideration substantially exceeds the value of the first number of points.

32. The method of claim 31, wherein the microtransactions comprise an exchange of the offered product or service for the first number of points.

33. The method of claim 31, wherein the first number of points is between about 25% and about 50% of the value of the received consideration.

34. The method of claim 31, wherein the first number of points is between about 25% and about 50% of the value of the received consideration.

35. The method of claim 31, wherein the first number of points is less than about 1% of the value of the received consideration.

36. The method of claim 31, wherein the provided access is communicated over an electronic communication channel.

37. The method of clam 36, wherein the electronic communication channel comprises a wireless communication channel.
